(19) United States
(12) Patent Application Publication
(10) Pub. No.: US 2007/0242149 A1
(43) Pub. Date: Oct. 18, 2007

(54) Image display control apparatus, method of controlling the same, and control program therefor

(75) Inventor: Yitong Zhang, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/783,844

(22) Filed: Apr. 12, 2007

(30) Foreign Application Priority Data
Apr. 14, 2006 (JP) 2006-111532

(51) Int. Cl. H04N 5/228

(52) U.S. Cl. 348/333.01; 348/222.1

(57) ABSTRACT

To display a face image portion having a desired facial expression. For this purpose, detection processing of a face image portion from a subject image is performed. When a plurality of face image portions are detected, facial expression analysis is performed for each of the face image portions. The face image portion having the facial expression previously designated is enlarged and displayed throughout a display screen.

### BACKGROUND OF THE INVENTION

1. Field of the Invention

The present invention relates to an image display control apparatus, a method of controlling the same, and a control program therefor.

2. Description of the Background Art

Digital still cameras have liquid crystal display screens formed on their rear surfaces. Images obtained by imaging (pickup) are displayed on the liquid crystal display screens. Since it is preferable that the digital still cameras are small in size, the sizes of the liquid crystal display screens are relatively small. Since small display screens make it difficult to confirm desired image portions from whole subject images, some digital still cameras may display parts of the subject images. Examples of the digital still cameras include one for displaying a desired image portion from a subject image utilizing the size of the image portion, for example (JP-A-2003-209683), one for manually selecting a desired image portion by a photographer and displaying the selected image portion (JP-A-2005-102175), one for photographing a face such that the size thereof is made constant (JP-A-11-84481), and one utilizing a facial dimension, a facial expression, and so on as retrieval information in an automatic retrieval system (JP-A-2001-167110).

In a case where there is a subject image obtained by imaging a plurality of characters, an image portion desired to be seen by a user is not necessarily a portion of the largest character image. The user may, in some cases, confirm at least a particular character image even if it is small.

### SUMMARY OF THE INVENTION

An object of the present invention is to display a face image portion having a desired facial expression and a particular object image portion.

An image display control apparatus according to a first invention is characterized by comprising a facial expression designation device that designates a facial expression desired to be noted, a notable facial expression detection device that detects a face image portion having the facial expression designated by the facial expression designation device from a subject image, and a display control device that controls a display device so as to display the face image portion detected by the notable facial expression detection device as an image corresponding to one frame on its display screen.

The first invention also provides a controlling method suitable for the image display control apparatus. That is, in this method, a facial expression designation device designates a facial expression desired to be noted, a notable facial expression detection device detects a face image portion having the facial expression designated by the facial expression designation device from a subject image, and a display control device controls a display device so as to display the face image portion detected by the notable facial expression detection device as an image corresponding to one frame on its display screen.

The first invention also provides a program for realizing the method of controlling the image display control apparatus.

According to the first invention, the facial expression desired to be noted is designated. The face image portion having the designated facial expression is detected from the subject image. The detected face image portion is displayed as the image corresponding to one frame on the display screen of the display device. Since the face image portion desired to be noted is displayed on the display screen, a user easily confirms the face image portion.

The image display control apparatus may further comprise a face image detection device that detects the face image portion from the subject image. In this case, the notable facial expression detection device will detect, in response to the fact that the face image detection device detects a plurality of face image portions, the face image portion having the facial expression designated by the facial expression designation device.

The display control device displays, when the notable facial expression detection device detects a plurality of face image portions, for example, the largest face image portion on the display screen, displays the face image portions one at a time as an image corresponding to one frame, or respectively displays the two or more face image portions on different areas of the display screen.

The facial expression designated by the facial expression designation device is at least one of a good facial expression, a bad facial expression, and a closed-eye facial expression, for example.

The image display control apparatus may further comprise an imaging device that images a subject and outputs image data representing a subject image. In this case, the notable facial expression detection device will detect the face image portion having the facial expression designated by the facial expression designation device from the subject image represented by the image data outputted from the imaging device. In this case, the image display control apparatus may further comprise a recording control device that associates the image data outputted from the imaging device and the data representing the face image portion detected by the notable facial expression detection device with each other and records the data on a recording medium.

The image display control apparatus may further comprise a reading device that reads from the recording medium on which the image data representing the subject image is recorded the image data. In this case, the notable facial expression detection device will detect the face image portion having the facial expression designated by the facial expression designation device from the subject image represented by the image data outputted from the imaging device.

An image display control apparatus according to a second invention is characterized by comprising an object detection device that detects an object image portion from a subject image; a determination device that determines whether or not the object image portion detected by the object detection device includes a particular object image portion; and a display control device that controls a display device so as to display, in response to the fact that the determination device determines that the particular object image portion is included, the particular object image portion as an image corresponding to one frame on its display screen.

The second invention also provides a controlling method suitable for the image display control apparatus. That is, in this method, an object detection device detects an object image portion from a subject image, a determination device determines whether or not the object image portion detected by the object detection device includes a particular object image portion, and a display control device controls a display device so as to display, in response to the fact that the determination device determines that the particular object image portion is included, the particular object image portion as an image corresponding to one frame on its display screen.

The second invention also provides a program for realizing the method of controlling the image display control apparatus.

According to the second invention, the object image portion is detected from the subject image. It is determined whether or not the detected object image portion includes the particular object image portion. When it is determined that the particular object image portion is included, the particular object image portion is displayed as the image corresponding to one frame on the display screen. The particular object image portion can be displayed on the display screen from the object image portion. Considering a face image portion as the object image portion, for example, the particular object image portion is considered as an image portion of a desired human face (one's own face, one's child's face, or one's acquaintance's face) or a desired pet (cat, dog, etc.).

The determination device determines, when the object detection device detects a plurality of object image portions, for example, whether or not the object image portions detected by the object detection device include the particular object image portion.

The display control device displays, when the determination device determines that the plurality of object image portions include a plurality of particular object image portions, for example, the largest particular object image portion on the display screen, displays the particular object image portions one at a time as an image corresponding to one frame, or respectively displays the two or more particular object image portions on different areas of the display screen.

The image display control apparatus may further comprise an imaging device that images a subject and outputs image data representing a subject image. In this case, the object detection device will detect the object image portion from the subject image represented by the image data outputted from the imaging device. In this case, the image display control apparatus may further comprise a recording control device that associates the image data outputted from the imaging device and data representing the object image portion detected by the object detection device with each other and records the data on a recording medium.

The image display control apparatus may further comprise a reading device that reads from the recording medium on which the image data representing the subject image is recorded the image data. In this case, the object detection device will detect the object image portion from the subject image represented by the image data outputted from the imaging device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the electrical configuration of a digital still camera;

FIG. 2 is a flow chart showing the procedure for recording processing;

FIG. 3 and FIG. 4 respectively show examples of a subject image;

FIG. 5 shows an example of an enlarged face image portion;

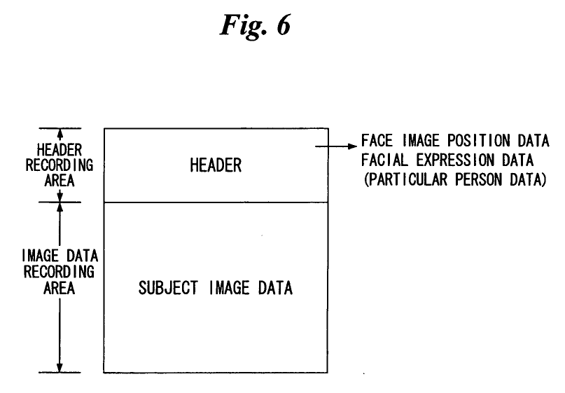

FIG. 6 shows the file structure of an image file;

FIG. 7 and FIG. 8 are flow charts respectively showing the procedures for recording processing; and

FIG. 9 is a flow chart showing the procedure for reproduction processing.

### DESCRIPTION OF THE PREFERRED EMBODIMENTS

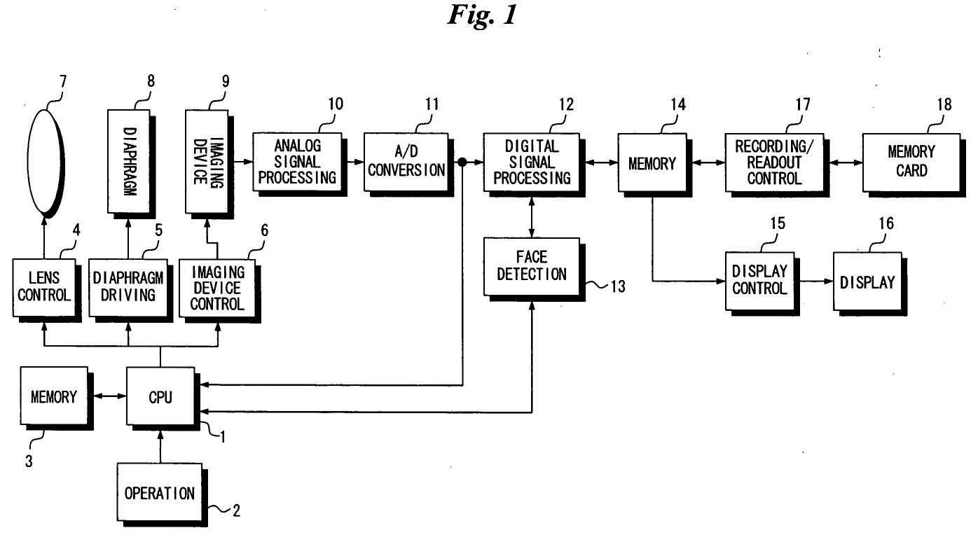

FIG. 1 is a block diagram showing the electrical configuration of a digital still camera, showing an embodiment of the present invention.

The overall operation of the digital still camera is supervised by a CPU 1.

An output signal from an operation switch such as a shutter release button, a mode switch (an imaging mode, a reproduction mode, etc.), a menu button, or an OK button is inputted to the CPU 1. A memory 3 storing an operation program, predetermined data, etc. is connected to the CPU 1. When a memory card 18 stores the operation program, the operation program recorded on the memory card 18 is read and is installed in the digital still camera, to perform operations, described later. Further, the CPU 1 controls a lens control circuit 4 for controlling the position of an imaging lens 7, a diaphragm driving circuit 5 for controlling the f-stop value of a diaphragm 8, and an imaging device control circuit 6 for controlling an imaging (pickup) device 9.

When the imaging mode is set, a bundle of rays concentrated by the imaging lens 7 is incident on a light receiving surface of the imaging device 9 after passing through the diaphragm 8. A subject image is formed on the light receiving surface of the imaging device 9. A video signal representing the subject image is outputted from the imaging device 9, and is inputted to an analog signal processing circuit 10. The video signal is subjected to predetermined analog signal processing such as gamma correction and white balance correction in the analog signal processing circuit 10, and is inputted to an analog-to-digital conversion circuit 11. In the analog-to-digital conversion circuit 11, an analog video signal is converted into digital image data. The digital image data obtained by the conversion is inputted to the CPU 1, where the position of the imaging lens 7, the f-stop value of the diaphragm 8, the shutter speed, etc. are adjusted.

The digital image data outputted from the analog-to-digital conversion circuit 11 is also inputted to a digital signal processing circuit 12. In the digital signal processing circuit 12, the digital image data is subjected to predetermined signal processing such as production of luminance data and color difference data. In the present embodiment, a face image portion can be detected from the subject image. Thus, the digital still camera is provided with a face detection circuit 13. The image data outputted from the digital signal processing circuit 12 is inputted to the face detection circuit 13, where the face image portion is detected from the subject image obtained by the imaging. In the present embodiment, not only the face image portion but also a face image portion having a desired facial expression, a face image portion related to a particular character, and so on can be detected. The processing will be described in detail later.

The image data outputted from the digital signal processing circuit 12 is also inputted to a display control circuit 15 after merely passing through a memory 14. In the display control circuit 15, a display device 16 is controlled, so that the subject image (or the detected face image portion, etc.) is displayed on a display screen of the display device 16.

When the shutter release button is pressed, the image data outputted from the digital signal processing circuit 12 in the above-mentioned manner is applied to the memory 14, and is temporarily stored therein. The image data is read out of the memory 14, and is applied to a recording/readout control circuit 17. The recording/readout-control circuit 17 records image data representing the subject image on the memory card 18.

When the reproduction mode is set, the image data recorded on the memory card 18 is read by the recording/readout control circuit 17. The read image data is applied to the display control circuit 15 through the memory 14. The display control circuit 15 controls the display device 16, so that the subject image represented by the image data recorded on the memory card 18 is displayed on the display screen of the display device 16.

In the digital still camera according to the present embodiment, the face image portion can be detected even at the time of reproduction. The image data read from the memory card 18 is inputted to the face detection circuit 13 through the recording/readout control circuit 17, the memory 14, and the digital signal processing circuit 12. In the face detection circuit 13, the face image portion is detected from the subject image represented by the read image data.

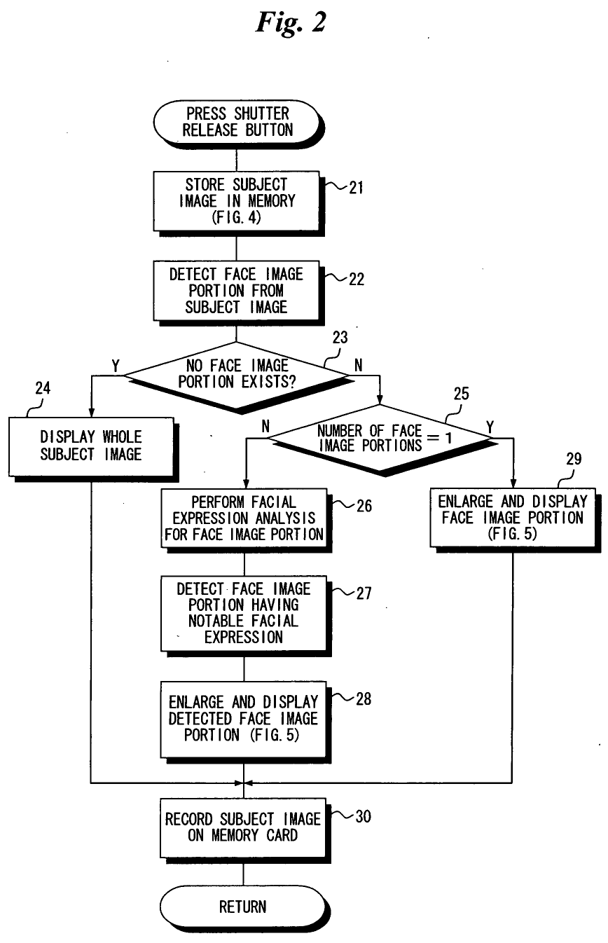

FIG. 2 is a flow chart showing the procedure for recording processing.

This processing is such that a facial expression is previously designated, and a face image portion having the designated facial expression is found and displayed. A facial expression will be designated by pressing the menu button, for example, to display menus on the display screen of the display device 16 and select from a list of facial expressions the facial expression. Examples of the facial expressions include a good facial expression (a laughing face), a bad facial expression (an angry face), and a closed-eye facial expression. The shape of eyes, the shape of eyebrows, the shape of a mouth, etc. are previously determined for each of the facial expressions.

When the shutter release button is pressed, the image data obtained in the above-mentioned manner is temporarily stored in the memory 14 (step 21).

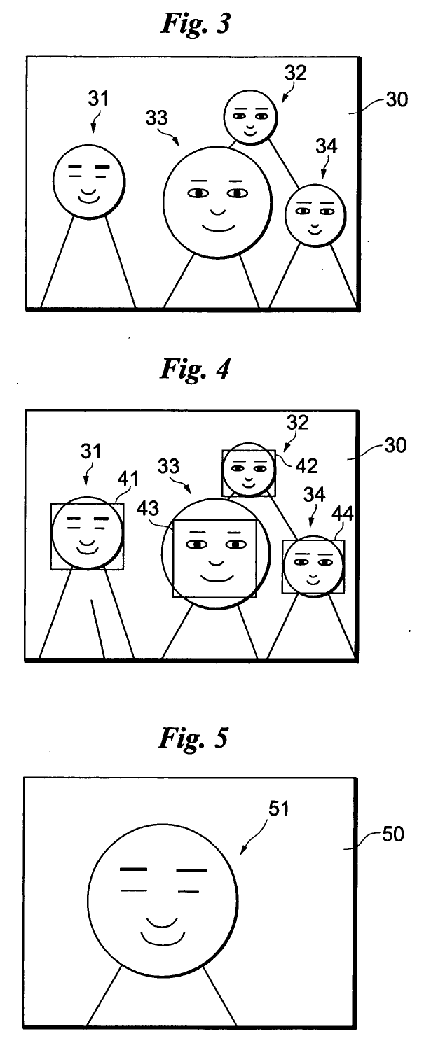

FIG. 3 illustrates an example of a subject image represented by the image data stored in the memory 14.

It is assumed that a subject image 30 obtained by imaging includes character images 31, 32, 33, and 34.

Returning to FIG. 2, the image data is read from the memory 14 and is inputted to the face detection circuit 13. The face detection circuit 13 detects a face image portion from the subject image 30 obtained by the imaging (step 22).

FIG. 4 illustrates an example of a subject image that has been subjected to face detection processing.

As described above, the subject image 30 includes the character images 31, 32, 33, and 34. Face image portions 41, 42, 43, and 44 of the character images 31, 32, 33, and 34 are detected by performing the face detection processing.

Returning to FIG. 2 again, when a face image portion exists in the subject image 30 (No in step 23), it is confirmed whether or not the number of face image portions is one (step 25). If the number of face image portions is one, the one face image portion is treated as an image corresponding to one frame, and is enlarged and displayed throughout the display screen of the display device 16 (step 29).

Unless the number of face image portions is one (No in step 25), facial expression analysis is performed for each of the face image portions (step 26). As a result of the facial expression analysis, the face image portion having a facial expression previously designated is detected out of the plurality of face image portions (step 27). The detected face image portion is enlarged and displayed throughout the display screen of the display device 16 (step 28).

Referring to FIG. 4 again, when a laughing facial expression is previously designated such that a face image portion having the facial expression is displayed, and the face image portion 41 out of the face image portions 41, 42, 43, and 44 is detected as one having the designated facial expression, the face image portion 41 is enlarged. An enlarged image 51 is displayed on a display screen 50 of the display device 16. Although the enlarged image 51 also includes an image portion around the periphery of the face image portion 41, it goes without saying that the necessity of displaying the image 51, including the portion around the periphery of the face image portion 41, is eliminated. The face image portion having the designated facial expression is thus displayed.

When there are a plurality of face image portions having the designated facial expression, the largest face image portion may be displayed throughout the display screen 50. Alternatively, the plurality of face image portions may be displayed in order throughout the display screen 50. Alternatively, the display screen may be divided into a plurality of areas, to respectively display the detected face image portions (having the designated facial expression) in the areas.

When no face image portion exists in the subject image, the whole subject image obtained by the imaging is displayed on the display screen of the display device 16 (step 24).

When the face image portion or the like is displayed, image data representing the subject image is recorded on the memory card 18 (step 29). Since the user can confirm the face image portion having the designated facial expression, the image data representing the subject image may be recorded on the memory card 18 in response to issue of a recording command from the user, for example, press of the OK button.

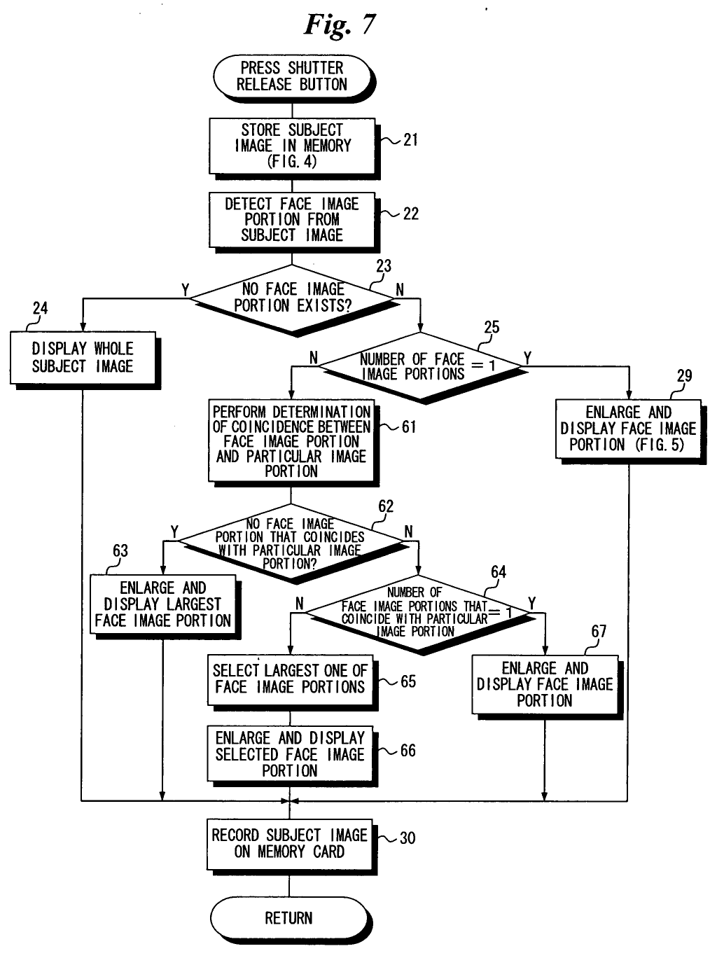

FIG. 6 shows an example of the file structure (data structure) of an image file recorded on the memory card 18.

The image file is generated by the CPU 1.

The image file includes a header recording area and an image data recording area.

A header including management information for the image file is recorded on the header recording area. Face image position data representing the position in the subject image of the face image portion (the face image portion having the designated facial expression) detected in the above-mentioned manner and facial expression data representing the designated facial expression are also recorded on the header recording area. Data representing the position of a face image portion of a particular person and data representing the particular person may be also recorded.

Subject image data representing the whole subject image is recorded on the image data recording area.

Since the face image position data is recorded on the header recording area, the detected face image portion can be specified when the subject image data recorded on the image data recording area is reproduced. Since the facial expression data is also recorded on the header recording area, it can be confirmed what facial expression the detected face image portion has.

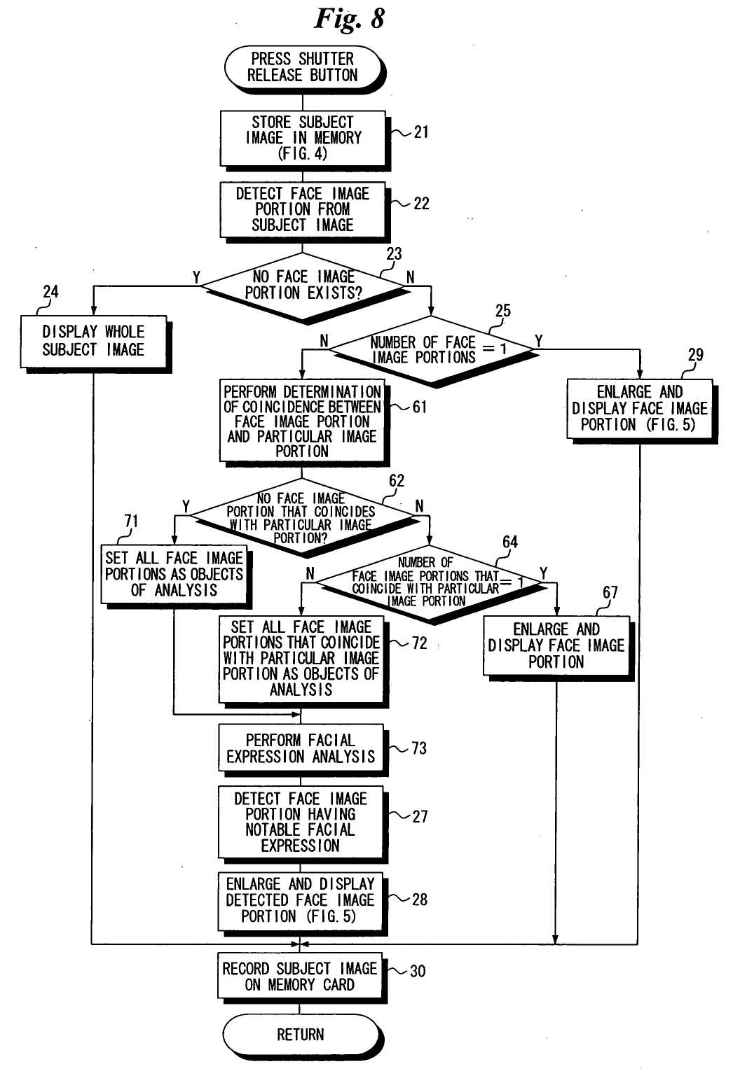

FIG. 7 is a flow chart showing the procedure for recording processing, showing another embodiment.

The procedure for processing is for detecting a face image portion of a particular person (e.g., a user himself or herself, a user's child, a user's friend, etc.) out of face image portions and displaying the detected face image portion. It goes without saying that image data representing the face image portion of the particular person is previously stored in the memory 3. Further, the particular person shall be previously designated using the menu button or the like by the user. In this processing, the same processing steps as the processing steps shown in FIG. 2 are assigned the same reference numerals and hence, the description thereof is not repeated.

When a plurality of face image portions are detected (NO in step 25), determination processing whether or not each of the detected face image portions coincides with the face image portion of the particular person previously designated is performed (step 61).

When there is no face image portion that coincides with the face image portion of the particular person (YES in step 62), the face image portion that does not coincide with the face image portion of the particular person but is detected as a face image portion is enlarged and displayed on the display screen (step 63). When a plurality of face image portions are detected, the largest face image portion is displayed. Alternatively, the plurality of face image portions may be displayed in order. Alternatively, the display screen may be divided into a plurality of areas, to respectively display the face image portions in the areas.

When there is a face image portion that coincides with the face image portion of the particular person (NO in step 62), it is configured whether or not the number of face image portions that coincide therewith is one (step 64). When the number of face image portions that coincide with the face image portion of the particular person is one (NO in step 64), the face image portion is enlarged and displayed on the display screen (step 67). When there are a plurality of face image portions that coincide with the face image portion of the particular person (NO in step 64), the largest one of the face image portions that coincide therewith is selected (step 65). The selected face image portion is displayed on an enlarged display screen (step 66). A face image portion of a desired particular person is thus displayed. Even if the largest face image portion is not displayed, the face image portions that coincide with the face image portion of the particular person may be displayed in order. Alternatively, the display screen may be divided into a plurality of areas, to respectively display the face image portions that coincide with the face image portion of the particular person in the areas.

FIG. 8 is a flow chart showing the procedure for recording processing, showing still another embodiment.

The procedure for recording processing is for performing processing that is a combination of the processing shown in FIG. 2 and the processing shown in FIG. 7 and displaying, out of face image portions that coincide with a face image portion of a particular person, the face image portion having a designated facial expression. In the processing, the same processing steps as the processing steps shown in FIG. 2 or FIG. 7 are assigned the same reference numerals and hence, the description thereof is not repeated.

When there is no face image portion that coincides with the face image portion of the particular person out of the face image portions detected by face image detection processing (YES in step 62), all the detected face image portions are set as objects of facial expression analysis (step 71). When there is a face image portion that coincides with the face image portion of the particular person (NO in step 62), and when there exist a plurality of face image portions that coincide therewith, all the face image portions that coincide therewith are set as objects of facial expression analysis (step 72).

Facial expression analysis is performed for the face image portion thus set (step 73), and the face image portion having the designated facial expression is displayed as an image corresponding to one frame on a display screen, as described above (steps 27 and 28).

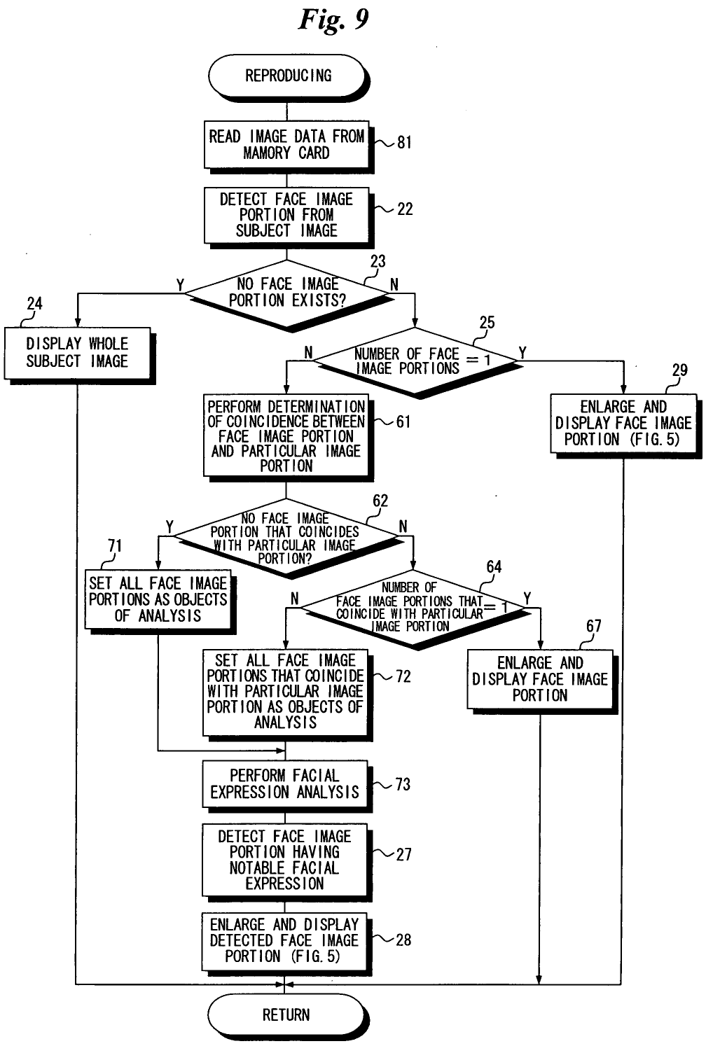

FIG. 9 is a flow chart showing the procedure for reproduction processing.

In FIG. 9, the same processing steps as the processing steps shown in FIG. 8 are assigned the same reference numerals and hence, the description thereof is not repeated. Although in the above-mentioned embodiment, the detection processing of the face image portion of the particular person and the detection processing of the face image portion having the designated facial expression are performed in the imaging processing, detection processing of a face image portion of a particular person and detection processing of a face image portion having a designated facial expression are performed in the reproduction processing in the present embodiment.

It is assumed that both the particular person and the facial expression have already been designated.

Image data is read from a memory card (step 81), and detection processing of a face image portion from a subject image represented by the read image data is performed (step 22). Thereafter, the detection processing of the face image portion of the designated. particular person and the detection processing of the face image portion having the designated facial expression are performed, as described above, and the found face image portion is displayed. Image portions of interest to a user, for example, an image of a user's child and an image having a good facial expression can be seen.

Although in the above-mentioned embodiment, the face image portion is displayed, not only the face image portion but also the whole of a particular character image can be displayed. Alternatively, only particular types of images out of animals and automobiles can be displayed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image display control apparatus comprising:
a facial expression designation device that designates a facial expression desired to be noted;
a notable facial expression detection device that detects a face image portion having the facial expression designated by the facial expression designation device from a subject image; and
a display control device that controls a display device so as to display the face image portion detected by the notable facial expression detection device as an image corresponding to one frame on its display screen.

2. The image display control apparatus according to claim 1, further comprising
a face image detection device that detects the face image portion from the subject image,
the notable facial expression detection device detecting, in response to the fact that the face image detection device detects a plurality of face image portions, the face image portion having the facial expression designated by the facial expression designation device.

3. The image display control apparatus according to claim 1, wherein
the display control device displays, when the notable facial expression detection device detects a plurality of face image portions, the largest face image portion on the display screen, displays the face image portions one at a time as an image corresponding to one frame, or respectively displays the two or more face image portions on different areas of the display screen.

4. The image display control apparatus according to claim 1, wherein
the facial expression designated by the facial expression designation device is at least one of a good facial expression, a bad facial expression, and a closed-eye facial expression.

5. The image display control apparatus according to claim 1, further comprising
an imaging device that images a subject and outputs image data representing a subject image,
the notable facial expression detection device detecting the face image portion having the facial expression designated by the facial expression designation device from the subject image represented by the image data outputted from the imaging device.

6. The image display control apparatus according to claim 1, further comprising
a recording control device that associates the image data outputted from the imaging device and the data representing the face image portion detected by the notable facial expression detection device with each other and records the data on a recording medium.

7. The image display control apparatus according to claim 1, further comprising
a reading device that reads from the recording medium on which the image data representing the subject image is recorded the image data,
the notable facial expression detection device detecting the face image portion having the facial expression designated by the facial expression designation device from the subject image represented by the image data outputted from the imaging device.

8. An image display control apparatus comprising:
an object detection device that detects an object image portion from a subject image;
a determination device that determines whether or not the object image portion detected by the object detection device includes a particular object image portion; and
a display control device that controls a display device so as to display, in response to the fact that the determination device determines that the particular object image portion is included, the particular object image portion as an image corresponding to one frame on its display screen.

9. The image display control apparatus according to claim 8, wherein
the determination device determines, when the object detection device detects a plurality of object image portions, whether or not the object image portions detected by the object detection device include the particular object image portion.

10. The image display control apparatus according to claim 8, wherein
the display control device displays, when the determination device determines that the plurality of object image portions include a plurality of particular object image portions, the largest particular object image portion on the display screen, displays the particular object image portions one at a time as an image corresponding to one frame, or respectively displays the two or more particular object image portions on different areas of the display screen.

11. The image display control apparatus according to claim 8, further comprising
an imaging device that images a subject and outputs image data representing a subject image,
the object detection device detects the object image portion from the subject image represented by the image data outputted from the imaging device.

12. The image display control apparatus according to claim 11, further comprising
a recording control device that associates the image data outputted from the imaging device and data representing the object image portion detected by the object detection device with each other and records the data on a recording medium.

13. The image display control apparatus according to claim 8, further comprising
a reading device that reads from the recording medium on which the image data representing the subject image is recorded the image data,
the object detection device detects the object image portion from the subject image represented by the image data outputted from the imaging device.

14. A method of controlling an image display control apparatus, wherein
a facial expression designation device designates a facial expression desired to be noted,
a notable facial expression detection device detects a face image portion having the facial expression designated by the facial expression designation device from a subject image, and
a display control device controls a display device so as to display the face image portion detected by the notable facial expression detection device as an image corresponding to one frame on its display screen.

15. A method of controlling an image display control apparatus, wherein
an object detection device detects an object image portion from a subject image,
a determination device determines whether or not the object image portion detected by the object detection device includes a particular object image portion, and
a display control device controls a display device so as to display, in response to the fact that the determination device determines that the particular object image portion is included, the particular object image portion as an image corresponding to one frame on its display screen.

16. A program for controlling an image display control apparatus for carrying out the procedures for:
designating a facial expression desired to be noted;
detecting a face image portion having the designated facial expression from a subject image, and
controlling a display device so as to display the detected face image portion as an image corresponding to one frame on its display screen.

17. A program for controlling an image display control apparatus for carrying out the procedures for:
detecting an object image portion from a subject image;
determining whether or not the detected object image portion includes a particular object image portion; and
controlling a display device so as to display, in response to the fact that the particular object image portion is included, the particular object image portion as an image corresponding to one frame on its display screen.
